(19) United States
(12) Patent Application Publication
(10) Pub. No.: US 2016/0135251 A1
(43) Pub. Date: May 12, 2016

(54) Control Circuit for Heating Textile Articles

(71) Applicant: Phihong USA Corporation, Fremont, CA (US)

(72) Inventors: Keith Hopwood, Fremont, CA (US); Song-Je Lin, Taipei City (TW)

(21) Appl. No.: 14/537,588

(22) Filed: Nov. 10, 2014

(51) Int. Cl. H05B 3/00; A41D 13/005

(52) U.S. Cl. CPC H05B 3/0014; A41D 13/0051

(57) ABSTRACT

An example heating control module includes a microcontroller, and a switch operatively coupled to the microcontroller. The switch is arranged to allow current to flow between a power supply and one or more heating elements during a closed state and to prevent current from flowing between the power supply and the heating elements during an open state. The microcontroller is configured to receive, from a user interface, an indication of a heating level, and transmit, in response to receiving the indication, a control signal to the switch such that a current waveform corresponding to the heating level flows between the power supply and the heating elements. The microcontroller is also configured to obtain, during the closed state of the switch, one or more measurements of the current delivered to the heating element, compare the one or more measurements to a lower threshold current, and open the switch upon determining that at least one measurement is less than the lower threshold current.

### TECHNICAL FIELD

This disclosure relates to control circuits for heating textile articles.

### BACKGROUND

Textile articles, such as blankets and clothing, are often used to protect a user from the cold. For example, a blanket can be draped over a user in order to keep himself warm while sitting or sleeping. As another example, a jacket or coat can be worn by a user in order to keep himself warm while walking outdoors.

In general, a textile article includes one or more layers of cloth or fabric that provide insulation and retain heat. In some cases, a textile article can also include one or more electric heating elements that actively generate heat to provide additional warmth.

### SUMMARY

Implementations of a control circuit for controlling a heated textile article are described below. One or more implementations can be used to automatically or semi-automatically regulate the operation of heating elements of a heated textile article based on various factors (e.g., based on comfort, convenience, and safety considerations), such that a user need not manually and repeatedly adjust the operation of the heating elements himself. One or more implementations are also compatible with a wide range of input voltages, such that different types of power supplies can be used interchangeably without requiring voltage conversion. This can potentially reduce cost, increase power efficiency, and increase the versatility of the control circuit in a broad range of applications. In general, in an aspect, a heating control module includes a microcontroller, and a switch operatively coupled to the microcontroller. The switch is arranged to allow current to flow between a power supply and one or more heating elements during a closed state and to prevent current from flowing between the power supply and the heating elements during an open state. The microcontroller is configured to receive, from a user interface, an indication of a heating level. The microcontroller is also configured to transmit, in response to receiving the indication, a control signal to the switch such that a current waveform corresponding to the heating level flows between the power supply and the heating elements. The microcontroller is also configured to obtain, during the closed state of the switch, one or more measurements of the current delivered to the heating element. The microcontroller is also configured to compare the one or more measurements to a lower threshold current, and open the switch upon determining that at least one measurement is less than the lower threshold current.

Implementations of this aspect may include one or more of the following features.

In some implementations, the microcontroller can be further configured to compare the one or more measurements to an upper threshold current, and open the switch upon determining that at least one measurement exceeds the upper threshold current.

In some implementations, a duration of each measurement can be substantially less than the period of time that the switch is closed.

In some implementations, the control signal can include a pulse-width modulated waveform having a duty cycle that is proportional to the heating level.

In some implementations, the control signal can include a periodic waveform having a frequency that is proportional to the heating level.

In some implementations, the microcontroller can be further configured to obtain a temperature measurement using a temperature sensor, determine whether the temperature measurement exceeds a threshold temperature, and upon determining that the measured temperature exceeds the threshold temperature, open the switch. The measured temperature can correspond to a temperature of the heating element.

In some implementations, the microcontroller can be further configured to obtain, over a second period of time, a plurality of temperature measurements using a temperature sensor, determine whether the temperature measurements correspond to a rate of decrease that exceeds a threshold rate of decrease, and upon determining that the temperature measures correspond to a rate of decrease that exceeds the threshold rate of decrease, open the switch. The temperature sensor can be disposed with an article of clothing to be worn by a user. The temperature measurements can correspond to a temperature from an area of the article of clothing that is intended to be close to the user.

In some implementations, the control signal can include a pulse-width modulated waveform. The microcontroller can be further configured to measure a voltage across the power supply, and set a maximum allowable duty cycle of the control signal based on the measured voltage. The microcontroller can be further configured to set a minimum allowable duty cycle of the control signal based on the measured voltage.

In some implementations, the heating control module can further include the power supply and the heating element.

In some implementations, the microcontroller can be further configured to obtain one or more acceleration measurements using an accelerometer, determine whether the acceleration measurements correspond to a recent movement, upon determining that the acceleration measurements do not correspond to a recent movement, open the switch.

In general, in another aspect, a heating control module includes a microcontroller, and a switch operatively coupled to the microcontroller. The switch is arranged to allow current to flow between a power supply and one or more heating elements during a closed state and to prevent current from flowing between the power supply and the heating elements during an open state. The microcontroller is configured to receive, from a user interface, an indication of a heating level. The microcontroller is also configured to receive measurement data from one or more sensors. The microcontroller is also configured to transmit, in response to receiving the measurement data, a control signal to the switch such that a current waveform corresponding to the heating level flows between the power supply and the heating elements. The microcontroller is also configured to obtain, during the closed state of the switch, one or more measurements of the current delivered to the heating element. The microcontroller is also configured to compare the one or more measurements to a lower threshold current, and open the switch upon determining that at least one measurement is less than the lower threshold current.

Implementations of this aspect may include one or more of the following features.

In some implementations, the one or more sensors can include a temperature sensor. The measurement data can include temperature measurements. The control signal can include a pulse-width modulated waveform having a duty cycle that corresponds to the heating level and the temperature measurements.

In some implementations, the microcontroller can be further configured to compare the one or more measurements to an upper threshold current, and open the switch upon determining that at least one measurement exceeds the upper threshold current.

In some implementations, a duration of each measurement can be substantially less than the period of time that the switch is closed.

In some implementations, the microcontroller can be further configured to obtain a temperature measurement using a temperature sensor, determine whether the temperature measurement exceeds a threshold temperature, and upon determining that the measured temperature exceeds the threshold temperature, open the switch. The measured temperature can correspond to a temperature of the heating element.

In some implementations, the microcontroller can be further configured to obtain, over a second period of time, a plurality of temperature measurements using a temperature sensor, determine whether the temperature measurements correspond to a rate of decrease that exceeds a threshold rate of decrease, and upon determining that the temperature measures correspond to a rate of decrease that exceeds the threshold rate of decrease, open the switch. The temperature sensor can be disposed with an article of clothing to be worn by a user. The temperature measurements can correspond to a temperature from an area of the article of clothing that is intended to be close to the user.

In some implementations, the control signal can include a pulse-width modulated waveform. The microcontroller can be further configured to measure a voltage across the power supply, and set a maximum allowable duty cycle of the control signal based on the measured voltage. The microcontroller can be further configured to set a minimum allowable duty cycle of the control signal based on the measured voltage.

In some implementations, the heating control module can further include the power supply and the heating element.

In some implementations, the microcontroller can be further configured to obtain one or more acceleration measurements using an accelerometer, determine whether the acceleration measurements correspond to a recent movement, and upon determining that the acceleration measurements do not correspond to a recent movement, open the switch.

In general, in another aspect, a heating control module includes a microcontroller, and a first switch and a second switch each operatively coupled to the microcontroller. The first switch is configured to toggle between a closed state and an open state based on a first control signal received from the microcontroller. The first switch is arranged to allow current to flow across the first switch during the closed state and to prevent current from flowing across the first switch during the open state. The second switch is configured to toggle between a closed state and an open state based on a second control signal received from the microcontroller. The second switch is arranged to allow current to flow across the second switch during the closed state and to prevent current from flowing across the second switch during the open state. When the first switch and the second switch are arranged to allow current to flow between a power supply and one or more heating elements when both switches are closed, and to prevent current from flowing between the power supply and the heating elements when at least one of the first switch or the second switch are open. The microcontroller is configured to receive, from a user interface, an indication of a heating level. The microcontroller is also configured to transmit, in response to receiving the indication, the first control signal to the first switch. When the first control signal is transmitted to the first switch and the second switch is closed, a current waveform corresponding to the heating level flows between the power supply and the heating elements. The microcontroller is also configured to obtain, during the closed state of the first switch, one or more measurements of the current delivered to the heating element. The microcontroller is also configured to compare the one or more measurements to a lower threshold current, and open the second switch upon determining that at least one measurement is less than the lower threshold current.

Implementations of these aspect may include one or more of the following features.

In some implementations, the microcontroller can be further configured to compare the one or more measurements to an upper threshold current, and open the second switch upon determining that at least one measurement exceeds the upper threshold current.

In some implementations, a duration of each measurement can be substantially less than the period of time that the first switch is closed.

In some implementations, the first control signal can include a pulse-width modulated waveform having a duty cycle that is proportional to the heating level.

In some implementations, the first control signal can include a periodic waveform having a frequency that is proportional to the heating level.

In some implementations, the microcontroller can be further configured to obtain a temperature measurement using a temperature sensor, determine whether the temperature measurement exceeds a threshold temperature, and upon determining that the measured temperature exceeds the threshold temperature, open the second switch. The measured temperature can correspond to a temperature of the heating element.

In some implementations, the microcontroller can be further configured to obtain, over a second period of time, a plurality of temperature measurements using a temperature sensor, determine whether the temperature measurements correspond to a rate of decrease that exceeds a threshold rate of decrease, and upon determining that the temperature measures correspond to a rate of decrease that exceeds the threshold rate of decrease, open the second switch. The temperature sensor can be disposed with an article of clothing to be worn by a user. The temperature measurements can correspond to a temperature from an area of the article of clothing that is intended to be close to the user.

In some implementations, the control signal can include a pulse-width modulated waveform. The microcontroller can be further configured to measure a voltage across the power supply, and set a maximum allowable duty cycle of the control signal based on the measured voltage. The microcontroller can be further configured to set a minimum allowable duty cycle of the control signal based on the measured voltage.

In some implementations, the heating control module can further include the power supply and the heating element.

In some implementations, the microcontroller can be further configured to obtain one or more acceleration measurements using an accelerometer, determine whether the acceleration measurements correspond to a recent movement, and upon determining that the acceleration measurements do not correspond to a recent movement, open the second switch.

In general, in another aspect, a system for determining when a textile article is being worn, the system includes one or more temperature sensors, and a microcontroller operatively coupled to the one or more temperature sensors. The temperature sensors are configured to obtain, over a period of time, a plurality of temperature measurements, and transmit the temperature measurements to the microcontroller. The microcontroller is configured to receive the temperature measurements from the temperature sensors, and determine whether the temperature measurements correspond to the textile article being removed from a user's body.

Implementations of these aspect may include one or more of the following features.

In some implementations, the microcontroller can be further configured to, upon determining that the temperature measurements correspond to the textile article being removed from the user's body, instructing a heat generating element disposed within the textile article to suspend heat generation.

In some implementations, determining whether the temperature measurements correspond to the textile article being removed from a user's body can include determining whether the temperature measurements correspond to a rate of decrease that exceeds a threshold rate of decrease, and upon determining that the temperature measures correspond to a rate of decrease that exceeds the threshold rate of decrease, determining that the temperature measurements correspond to the textile article being removed from a user's body.

In some implementations, the microcontroller can be further configured to, upon determining that the textile article is not being removed from the user's body, instructing a heat generating device associated with the textile article to generate heat.

In some implementations, the textile article can be an article of clothing to be worn by a user. The temperature measurements can correspond to a temperature from one or more areas of the article of clothing that are intended to be close to the user.

In some implementations, the system can further include a switch operatively coupled to the microcontroller. The switch can be arranged to allow current to flow between a power supply and one or more heating elements during a closed state and to prevent current from flowing between the power supply and the heating elements during an open state. The microcontroller can be configured to upon determining that the temperature measurements correspond to the textile article being removed from a user's body, open the switch. The microcontroller can be further configured to receive, from a user interface, an indication of a heating level. The microcontroller can be further configured to transmit, in response to receiving the indication, a control signal to the switch such that a current waveform corresponding to the heating level flows between the power supply and the heating elements. The microcontroller can be further configured to obtain, during the closed state of the switch, one or more measurements of the current delivered to the heating element. The microcontroller can be further configured to compare the one or more measurements to a lower threshold current, and open the switch upon determining that at least one measurement is less than the lower threshold current. The duty cycle of the control signal can be proportional to the heating level. The microcontroller can be further configured to obtain a temperature measurement temperature using the temperature sensors, determine whether the temperature measurement exceeds a threshold temperature, and upon determining that the measured temperature exceeds the threshold temperature, open the switch. The measured temperature can correspond to a temperature of the heating element. The microcontroller can be further configured to measure a voltage across the power supply, and determine a maximum allowable duty cycle of the control signal based on the measured voltage. The system can further include the power supply and the heating element. The microcontroller can be further configured to obtain one or more acceleration measurements using an accelerometer, determine whether the acceleration measurements correspond to a recent movement, and upon determining that the acceleration measurements do not correspond to a recent movement, open the switch.

In general, in another aspect, a heating control module includes a microcontroller, and a switch operatively coupled to the microcontroller. The switch is arranged to allow current to flow between a power supply and one or more heating elements during a closed state and to prevent current from flowing between the power supply and the heating elements during an open state. The microcontroller is configured to receive, from a user interface, an indication of a heating level. The microcontroller is also configured to transmit, in response to receiving the indication, a control signal to the switch such that a current waveform corresponding to the heating level flows between the power supply and the heating elements. The microcontroller is also configured to apply, during the open state of the switch, current to an electric circuit coupling the power supply and the heating elements. The microcontroller is also configured to obtain, during the open state of the switch, one or more measurements of the current delivered to the heating element. The microcontroller is also configured to compare the one or more measurements to a lower threshold current, and prevent the switch from closing upon determining that at least one measurement is less than the lower threshold current.

Implementations of these aspects may include one or more of the following features.

In some implementations, the microcontroller can be further configured to compare the one or more measurements to an upper threshold current, and open the switch upon determining that at least one measurement exceeds the upper threshold current.

In some implementations, a duration of each measurement can be substantially less than the period of time that the switch is closed.

In some implementations, the control signal can include a pulse-width modulated waveform having a duty cycle that is proportional to the heating level.

In some implementations, the control signal can include a periodic waveform having a frequency that is proportional to the heating level.

In some implementations, the microcontroller can be further configured to obtain a temperature measurement using a temperature sensor, determine whether the temperature measurement exceeds a threshold temperature, and upon determining that the measured temperature exceeds the threshold temperature, open the switch. The measured temperature can correspond to a temperature of the heating element.

In some implementations, the microcontroller can be further configured to obtain, over a second period of time, a plurality of temperature measurements using a temperature sensor, determine whether the temperature measurements correspond to a rate of decrease that exceeds a threshold rate of decrease, and upon determining that the temperature measures correspond to a rate of decrease that exceeds the threshold rate of decrease, open the switch. The temperature sensor can be disposed with an article of clothing to be worn by a user. The temperature measurements can correspond to a temperature from an area of the article of clothing that is intended to be close to the user.

In some implementations, the control signal can include a pulse-width modulated waveform. The microcontroller can be further configured to measure a voltage across the power supply, and set a maximum allowable duty cycle of the control signal based on the measured voltage. The microcontroller can be further configured to set a minimum allowable duty cycle of the control signal based on the measured voltage.

In some implementations, the heating control module can further include the power supply and the heating element.

In some implementations, the microcontroller can be further configured to obtain one or more acceleration measurements using an accelerometer, determine whether the acceleration measurements correspond to a recent movement, and upon determining that the acceleration measurements do not correspond to a recent movement, open the switch.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a schematic of a textile article including a heating element and electronics for activating the heating element.

FIG. 2 is a schematic of a textile article with a heating element, a microcontroller and a switch.

FIG. 3A shows an example PWM waveform and a corresponding current waveform.

FIG. 3B shows an example PWM waveform having a longer duty cycle than the PWM waveform shown in FIG. 3A, a corresponding current waveform.

FIG. 3C shows an example PWM waveform and a corresponding current waveform.

FIG. 4 is a schematic of a textile article with a heating element, a control module, and a temperature sensor.

FIG. 5A shows an example PWM waveform and a corresponding current waveform. Upper and lower threshold currents are also shown for periods of time that the switch is closed.

FIG. 5B shows an example PWM waveform and a corresponding current waveform having several variations in current.

FIG. 5C shows an example PWM waveform and a corresponding current waveform. Upper and lower threshold currents are also shown for periods of time that the switch is open

FIGS. 6A-B show an example implementation of a textile article having multiplying heating elements and temperature sensors.

FIG. 6C shows example temperature measurements taken from different regions of the textile article shown in FIGS. 6A-B.

FIG. 7 is a schematic of a textile article with two switches.

FIGS. 8A-B show example implementations of textile articles including components for heating the textile articles.

### DETAILED DESCRIPTION

Implementations of a control circuit for controlling a heated textile article are described below. One or more implementations can be used to automatically or semi-automatically regulate the operation of heating elements of a heated textile article based on various factors (e.g., based on comfort, convenience, and safety considerations), such that a user need not manually and repeatedly adjust the operation of the heating elements himself. One or more implementations are also compatible with a wide range of input voltages, such that different types of power supplies can be used interchangeably without requiring voltage conversion. This can potentially reduce cost, increase power efficiency, and increase the versatility of the control circuit in a broad range of applications.

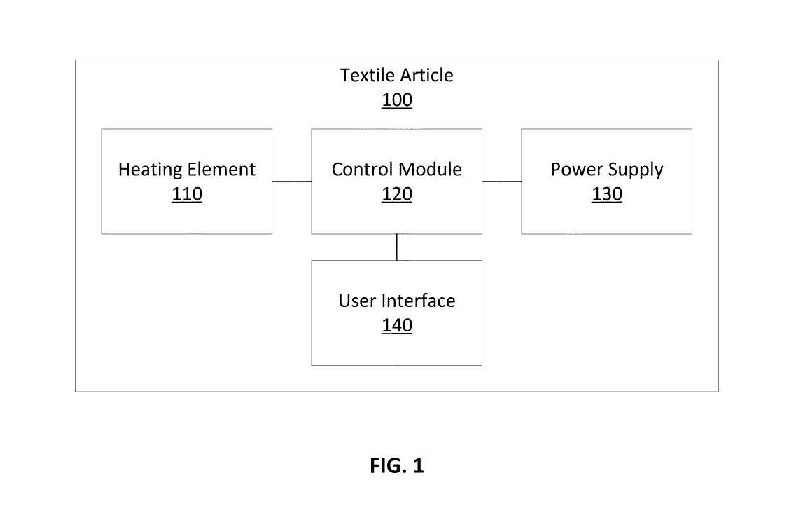

A simplified schematic of an electrically heated textile article 100 is shown in FIG. 1. The textile article 100 includes a heating element 110, a control module 120, a power supply 130, and a user interface 140. The control module 120 is electrically coupled to the heating element 110, the power supply 130, and the user interface 140, such that it can transmit electric current to and receive electric current from each of the components.

The heating element 110 generates heat using electric power. In some cases, the heating element 110 can generate heat by converting electricity into heat through the process of resistive heating. For example, the heating element 110 can include one or more resistive elements in series with a source of electric current (e.g., the power supply 130). As electric current flows through the resistive elements, the electric current encounters resistance, resulting in heating of the resistive element. Various types of heating elements can be used. For example, the heating elements 110 can include resistive elements either partially or completely composed of metal (e.g., nichrome, kanthal, or cupronickel foil or wires), ceramic (e.g., molybdenum disilicide or positive temperature coefficient ceramic elements), composites (e.g., metal-ceramic composites or metal alloy composites), or combinations thereof.

The control module 120 controls the operation of the textile article 100. For example, the control module 120 can be electrically coupled to the heating element 110 and the power supply 130 in order to regulate the flow of electric current between the power supply 130 to the heating element 110. In some cases, the amount of electric current that flows from the power supply 130 to the heating element 110 can be adjustable (e.g., selected by a user). For instance, a user can specify a particular level of heating using a user interface 140. The user interface 140 transmits the user's selection to the control module 120. Based on this selection, the control module 120 regulates the flow of current between the power supply 130 and the heating element 110 in order to provide the specified amount of heat. As an example, if the user selected a relatively high level of heating, the control module 120 can allow a relatively large amount of current to flow between the power supply 130 and the heating element 110 and/or allow current to flow between the power supply 130 and the heating element 110 for a relatively long period of time. As another example, if the user selected a relatively low level of heating, the control module 120 can allow a relatively small amount of current to flow between the power supply 130 and the heating element 110 and/or allow current to flow between the power supply 130 and the heating element 110 for a relatively short period of time.

In addition to regulating the current based on a user selection, the control module 120 can also regulate the current in accordance with one or more other factors. For example, the control module 120 can regulate the amount of current that flows from the power supply 130 to the heating element 110 such that the amount of heat generated by the heating element 110 remains at a safe level (e.g., by preventing the amount of current from exceeding a particular amount over a particular period of time). As another example, the control module 120 can determine if one or more components of the textile article 100 are malfunctioning, and discontinue or otherwise adjust the flow of current accordingly (e.g., by preventing current from flowing into damaged components). As another example, the control module 120 can determine if the textile article 100 is in use by a user, and likewise discontinue or otherwise adjust the flow of current accordingly (e.g., by suspending the generation of heat when the textile article 100 is not being worn). As yet another example, the control module 120 can determine the temperature of the environment surrounding the textile article 100, and adjust the flow of current such that a particular temperature is achieved and maintained. In this manner, the control module 120 automatically regulates the operation of the textile article 100 based on various comfort, convenience, and/or safety factors, such that a user need not manually and repeatedly adjust the operation of the textile article 100 himself.

The power supply 130 provides electric power for the textile article 100. For example, as described above, the power supply 130 can provide electric current to the heating element 110 in order to generate heat. As another example, the power supply 130 can also provide electric current to the control module 120 and the user interface 140. Various types of power supplies can be used. For example, the power supply 130 can include one or more devices that store electric energy (e.g., electrochemical cells or batteries) and release stored electric energy as needed by the textile article 100. As another example, the power supply 130 can include one or more devices that convert electricity for use by the textile article 100, for instance by converting electricity from an external source (e.g., alternating current from a wall outlet) into a form of electric energy that can be used by the textile article 100 (e.g., direct current). Although the power supply 130 is shown in FIG. 1 as being a part of the textile article 100, this need not be the case. For example, in some cases, the power supply 130 can be separate from the textile article 100 and can be electrically coupled to the textile article 100 prior to use (e.g., through a plug or other attachment interface).

The user interface 140 allows a user to control the operation of various aspects of the textile article 100. For example, as described above, the user interface 140 can allow the user to select a particular heating level (e.g., by specifying a desired temperature, such as a particular temperature value in degrees Celsius, or by specifying an arbitrary level of heating, such as “low,” “medium,” and “high”). As another example, the user interface 140 can allow the user to turn on or off the textile article 100. The user interface 140 can include one or more interactive elements that allow the user to make these selections. For example, the user interface 140 can include one or more buttons, dials, switches, and/or touch screens that allow a user to enter commands.

The user interface 140 can also present information to the user. For example, the user interface 104 can provide information regarding the operation of the textile article 100, including information such as the power state of the textile article 100, the selected heating level, the current temperature of the surrounding environment, the operational state of the heating elements (e.g., whether heating is turned on or turned off), and so forth. This information can be presented in the form of visual, auditory, and/or haptic feedback. For example, the user interface 140 can include one or more indicator lights, audio speakers, video displays, or haptic feedback devices that can be used to provide the user with information. In some cases, the user interface 140 can include components that include a combination of interactive elements and information presentation elements. For instance, the user interface 140 can include one or more buttons that illuminate differently depending on the operational state of the textile article 100. As an example, the button can illuminate according to different patterns, degrees brightness, and/or colors to indicate information such as heating level and/or power state.

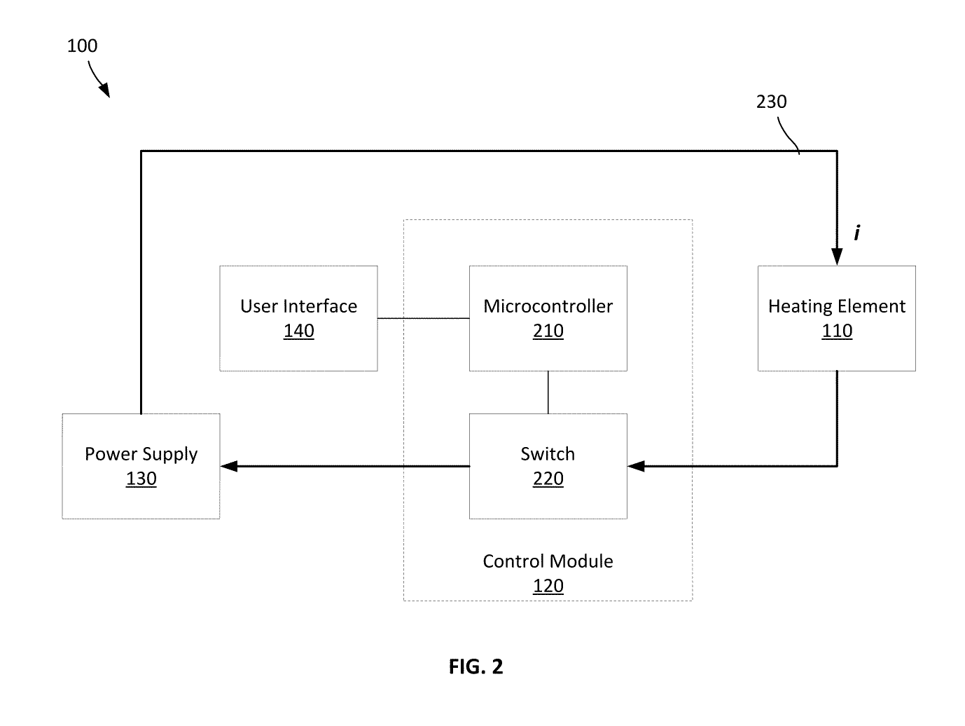

As described above, in some implementations, the control module can be electrically coupled between the power supply 130 and the heating element 110 in order to regulate the flow of current between these two components. An example textile article 100 having this arrangement is shown in FIG. 2. As shown in FIG. 2, the control module 120 includes a microcontroller 210 and a switch 220. The switch 220 is electrically coupled in series with the power supply 130 and the heating element 110, such that a path for electric current is formed between the power supply 130 and the heating element 110, between the heating element 110 and the switch, and between the switch 220 and the power supply 130. When the switch 220 is closed, an electric circuit is formed. Accordingly, the electric current i flows from the power supply 130 to the heating element 110 and back (e.g., in the direction of the arrow 230), resulting in the generation of heat. When the switch 220 is open, the circuit is broken. Accordingly, electric current does not flow from the power supply 130 to the heating element 110, and no heat is generated. Various types of switches can be used, include transistor switches or relay switches.

The opening and closing of the switch 220 is controlled by the microcontroller 210. As described above, the flow of current can be controlled based on the selection by a user. For instance, a user can specify a particular level of heating using a user interface 140. The user interface 140 transmits the user's selection to the microcontroller 210. Based on this selection, the microcontroller 210 regulates the flow of current between the power supply 130 and the heating element 110 in order to provide the specified amount of heat. As an example, if the user selected a relatively high level of heating, the microcontroller 210 can operate the switch 220 such that a relatively large amount of current flows between the power supply 130 and the heating element 110 and/or current flows between the power supply 130 and the heating element 110 for a relatively long period of time. As another example, if the user selected a relatively low level of heating, the microcontroller 210 can operate the switch 220 such that a relatively small amount of current flows between the power supply 130 and the heating element 110 and/or current flows between the power supply 130 and the heating element 110 for a relatively short period of time.

In some cases, the microcontroller 210 can control the operation of the switch 220 through the use of pulse-width modulation (PWM) waveforms. A PWM waveform can be, for example, a square-wave (or approximately square-wave) signal that includes one or more square (or approximately square) pulses occurring at a particular frequency. During a pulse, the signal is said to be “active.” Between pulses, the signal is said to be “inactive.” Hence, the PWM waveform switches between active and inactive states according to a particular frequency.

During operation, the microcontroller 210 generates a PWM waveform and transmits the PWM waveform to the switch 220. When the switch 220 encounters a pulse (e.g., the active portion of the PWM waveform), the switch 220 closes. This allows electric current to flow from the power supply 130 to the heating element 110, and results in the generation of heat by the heating element 110. The switch 220 remains closed during the duration of the pulse, and the heating element 110 continues to generate heat. When the switch 220 encounters the end of the pulse (e.g., the inactive portion of the PWM waveform), the switch 220 opens. This prevents electric current from flowing from the power supply 130 to the heating element 110, and discontinues the generation of theat. Thus, the heating element 110 generates heat based on the frequency, duration, and length of the pulses of the PWM waveform.

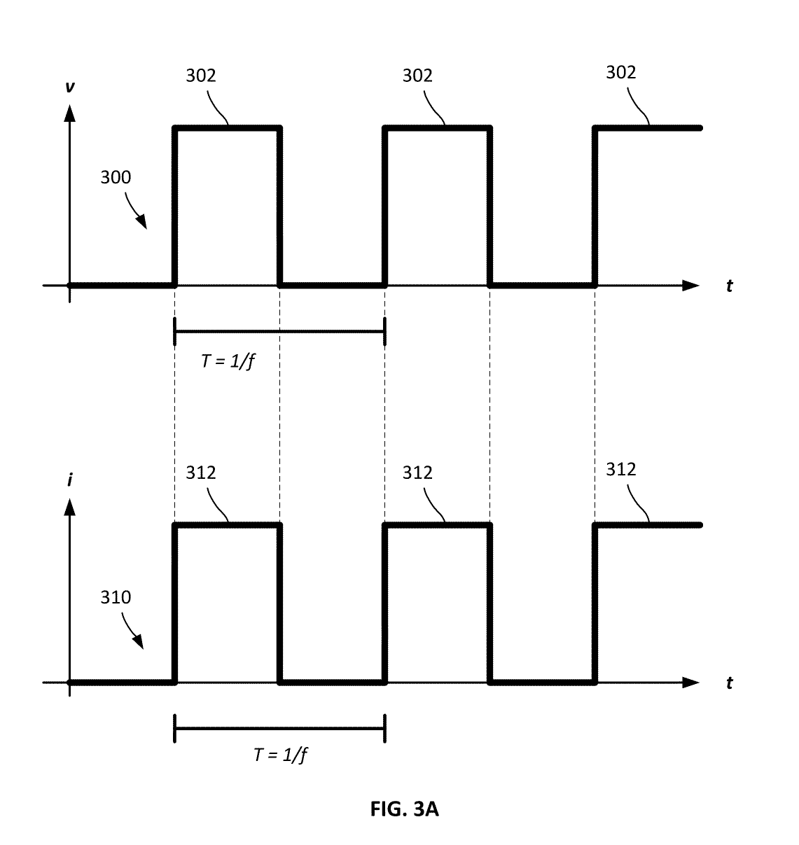

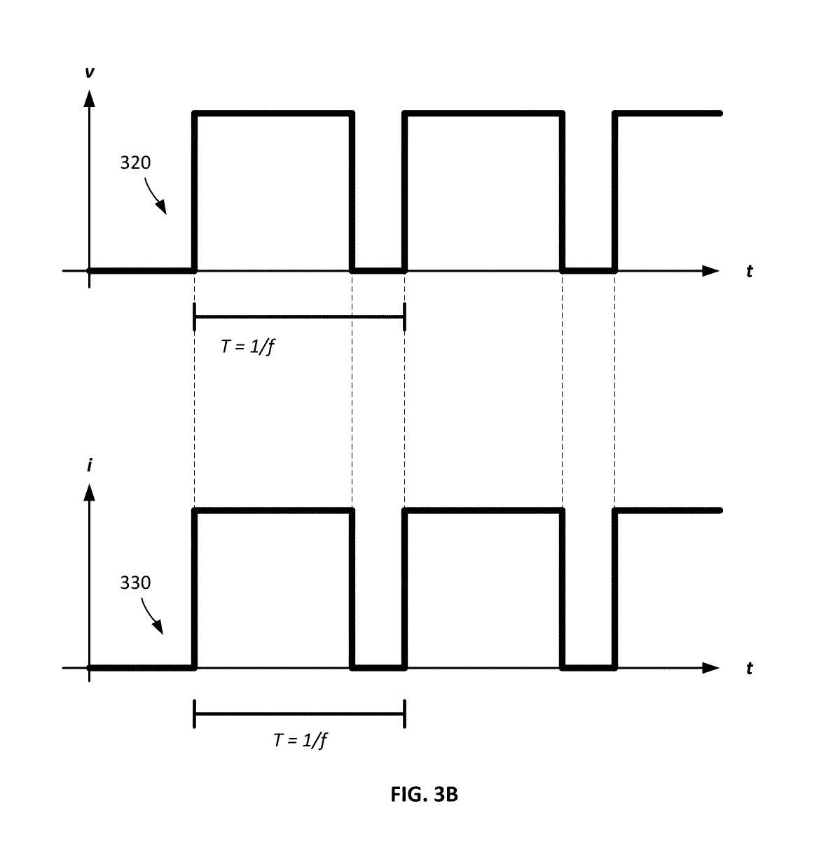

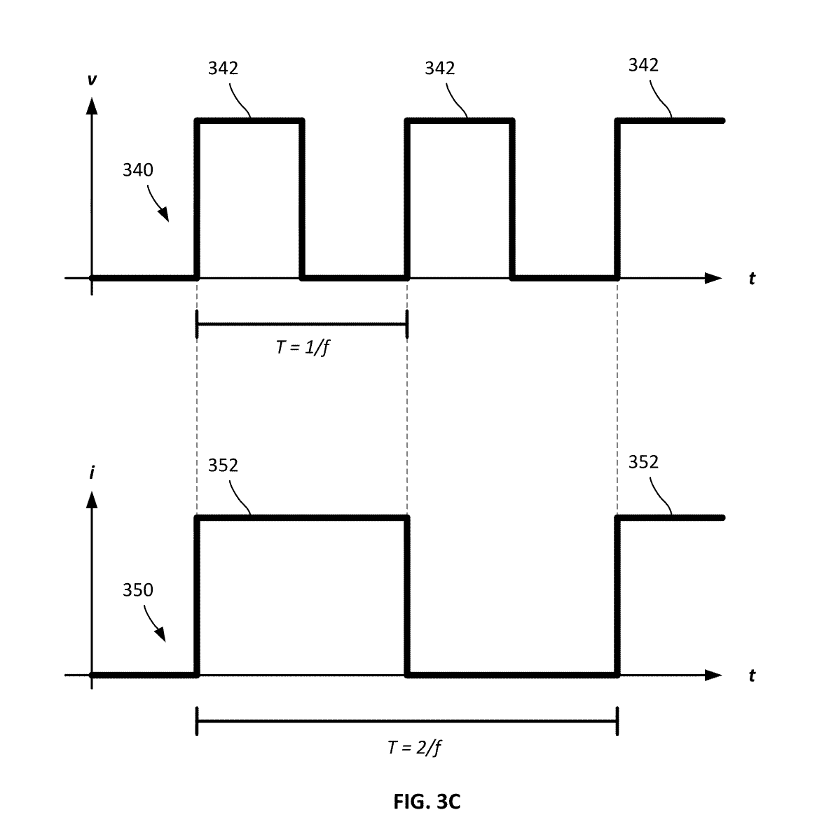

An example of a PWM waveform 300 is shown in FIG. 3A. The PWM waveform 300 includes several pulses 302 occurring at a frequency f, corresponding to a period T of 1/f. During each of the pulses 302, the PWM waveform 300 is “active.” Between each of the pulses 302, the PWM waveform 300 is “inactive.” FIG. 3A also shows an example current waveform 310 that results between the power supply 130 and the heating element 110 when the PWM waveform 300 is applied to the switch 220. The current waveform 310 includes several pulses 312 occurring at a frequency f, corresponding to a period T of 1/f (similar to that of the PWM waveform 300). Each of the pulses 312 corresponds to a respective pulse 302 of the PWM waveform 300, indicating that current flows when the PWM waveform 300 is “active,” and that current does not flow when the PWM waveform 300 is “inactive.”

The characteristics of each PWM waveform can vary in order to provide varying amounts of heat. For example, as described above, PWM waveform can have pulses that occur at a particular frequency f. Thus, the switch 220 will open and close according to the frequency f, and the heating element 110 will likewise receive current and generate heat according to the frequency f. Hence, the heating behavior of the heating element 110 can be controlled, at least in part, by adjusting the frequency f of pulses in the PWM waveform.

As another example, a PWM waveform can have a particular duty cycle. For example, a PWM waveform can have a 10% duty cycle, such that the PWM waveform is “active” for 10% of each period T, and inactive for 90% of each period T. As another example a PWM waveform can have a 50% duty cycle, is active such that the PWM waveform is “active” for 50% of each period T, and inactive for 50% of each period T. As the switch 220 opens and closes according to when the PWM waveform in active or inactive, the percentage of time that the switch 220 is open or closed during each period T depends on the duty cycle of the PWM waveform. Accordingly, the heating behavior of the heating element 110 can be controlled, at least in part, by adjusting the duty cycle of the PWM waveform.

The microcontroller 210 can generate different PWM waveforms in order to obtain different levels of heat. For example, if no heat is desired (e.g., if the user specifies that no heat should be generated using the user interface 140), the microcontroller 210 can generate a PWM waveform with a 0% duty cycle (e.g., an always inactive signal), and transmit this signal to the switch 220. As the signal is inactive during every portion of the period T, the switch 220 remains open throughout the duration of the PWM waveform. Accordingly, no electric current flows from the power supply 130 to the heating element 110, and no heat is generated by the heating element 110.

As another example, if a particular amount of heat is desired (e.g., if the user selects a “medium” level of heating during the user interface 140), the microcontroller 210 can generate a PWM waveform with a particular duty cycle (e.g., a 50% duty cycle), and transmit this signal to the switch 220. Accordingly, for 50% of every period T, the switch 220 is closed, and allows current to flow from the power supply 130 to the heating element 110. Thus, the heating element 110 generates heat during approximately 50% of each period T. This is shown, for example, in FIG. 3A, where a PWM waveform 300 having a 50% duty cycle results in current flowing between the power supply 130 and the heating element 110 for 50% of every period T (as shown by the current waveform 310).

As another example, if a greater amount of heat is desired (e.g., if the user selects a “high” level of heating), the microcontroller 210 can generate a PWM waveform with a larger duty cycle (e.g., a 75% duty cycle), and transmit this signal to the switch 220. Accordingly, for 75% of every period T, the switch 220 is closed, and allows current to flow from the power supply 130 to the heating element 110. Thus, the heating element 110 generates heat for approximately 75% of each period T, thereby generating a greater amount of heat. This is shown, for example, in FIG. 3B, where a PWM waveform 320 having a 75% duty cycle results in current flowing between the power supply 130 and the heating element 110 for 75% of every period T (as shown by the current waveform 330). Thus, increasing the duty cycle of the PWM waveform causes more current to flow through the heating element 110 over each period T, resulting in increased heat generation.

In this manner, the microcontroller 210 generates different PWM waveforms with different duty cycles in order to control the operation of switch 220 and to generate the desired amount of heating. Although example duty cycles and heating levels are described above, these are merely illustrative examples. In practice, different combinations of heating level and duty cycle can be used, either in addition to or instead of those described above, in order to achieve the desired effect.

In the example shown in FIGS. 3A-B, the PWM waveforms and the resulting current waveform largely correspond to each other. That is, when the PWM waveform is “active,” the corresponding current waveform is non-zero. However, this need not be the case. For example, in some cases, the switch 220 can be a switch that maintains its state after it is actuated, and changes state when it is actuated again (e.g., a latch switch). Thus, each time the switch 220 encounters an active portion of the PWM waveform, it can switch between open and closed states. For example, as shown in FIG. 3C, the PWM waveform 340 includes several pulses 342 occurring at a frequency f, corresponding to a period T of 1/f. FIG. 3C also shows an example current waveform 350 that results between the power supply 130 and the heating element 110 when the PWM waveform 340 is applied to a latch switch 220. The current waveform 350 includes several pulses 352 occurring at a frequency f/2, corresponding to a period T of 2/f (twice that of the PWM waveform 340). Thus, in this example, the PWM waveform can varied by changing the frequency and spacing between the leading edges of pulses 342 in order to selectively open and close the switch 220. Although two different types of switches 220 are described above, other types of switches are also possible, depending on the implementation. Accordingly, the PWM waveforms used to control these switches can also vary, depending on the implementation.

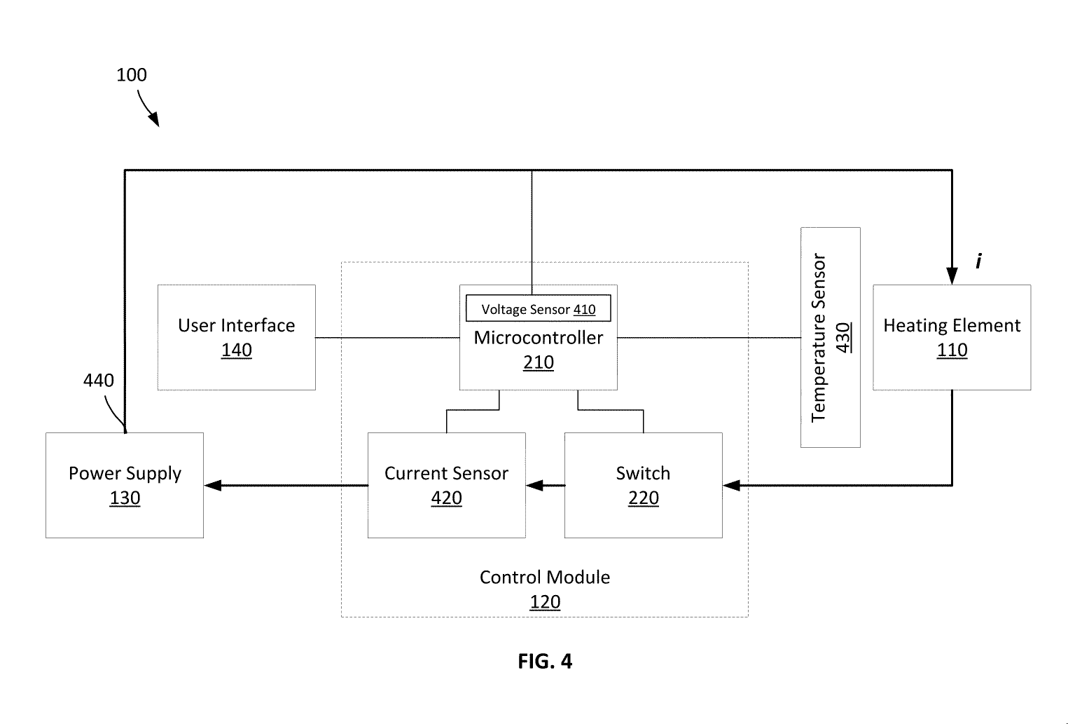

In some implementations, the control module can regulate current between the power supply 130 and the heating element based on measurements obtained from one or more sensors. An example textile article 100 having this arrangement is shown in FIG. 4. The textile article 100 is similar to that shown in FIG. 2. For example, the textile article 100 of FIG. 4 includes a control module 120 with a microcontroller 210 and a switch 220. As described above, the switch 220 is electrically coupled in series between the power supply 130 and the heating element 110, such that a path for electric current is formed between the power supply 130 and the switch 220, between the switch 220 and the heating element 110, and between the heating element 110 and the power supply 130. When the switch 220 is closed, the electric current flows from the power supply 130 to the heating element 110 and back, resulting in the generation of heat. When the switch 220 is open, electric current does not flow from the power supply 130 to the heating element 110, and no heat is generated.

The textile article 100 also includes a voltage sensor 410, a current sensor 420, and a temperature sensor 430. Each of the sensors 410, 420, and 430 are electrically coupled to the microcontroller 210, such that they can transmit electrical measurement signal to the microcontroller 210.

The voltage sensor 410 measures the voltage of the power supply 130. Example voltage sensors 410 include voltage-sensitive integrated circuit. In some cases, the voltage sensor 410 can be implemented, either partially or completely, as a part of the microcontroller 210. For example, the microcontroller 210 can include an analog to digital input for measuring voltage. The voltage inputted into this analog to digital input can be scaled as necessary, for example, by dividing the input voltage using one or more resistors. As shown in FIG. 4, the voltage sensor 410 can be electrically coupled to a voltage terminal 440 of the power supply 130, such that it can measure the voltage of the power supply 130. Voltage measurement obtained by the voltage sensor 410 are transmitted from the voltage sensor 410 for analysis by the microcontroller 210. Based on the voltage measurement, the microcontroller 210 can adjust the operation of the switch 220.

For example, given two different power supplies 130, each having different voltages, coupling the higher voltage power supply 130 with the heating element 110 will result into a greater amount of current flowing through the heating element 110. Thus, all other factors being equal, the textile article 100 will generate more heat using the higher voltage power supply 130. To account for this potential difference in heating, the microcontroller 210 can adjust the operation of switch 220, such that the amount of current that flows from the power supply 130 to the heating element 110 is adjusted based on the measured voltage.

For example, if a relatively high voltage is detected, the microcontroller 210 can adjust the switch so that a PWM waveform with a relatively low duty cycle (e.g., 25%) is transmitted to the switch 220. As another example, if a relatively low voltage is detected, the microcontroller 210 can adjust the switch so that a PWM waveform with a relatively high duty cycle (e.g., 50%) is transmitted to the switch 220. Thus, given a relatively high voltage power supply, the switch 220 is closed for a relatively small percentage of each period. Accordingly, the heating element 110 generates heat for a relatively short percentage of each period to account for the relatively large amount of current supplied by the power supply 130. Alternatively, given a relatively low voltage power supply, the switch 220 is closed for a relatively large percentage of each period. Accordingly, the heating element 110 generates heat for a relatively large percentage of each period to account for the relatively small amount of current supplied by the power supply 130. In this manner, the microcontroller 210 can regulate the flow of current from the power supply 130 to the heating element 110 to account for different voltages of the power supply 130, and to achieve relatively uniform heating despite differences in input voltage.

In some cases, the microcontroller 210 can regulate the flow of current in order to maintain constant (or nearly constant) power delivery to the heating element 110. In some cases, this can be performed according to Ohm's law. As an example, the power P delivered to the heating element can be defined as P=IV=V²/R, where I is the current, and R is the resistance of the heating element. The power P can be set to a particular value (e.g., a power value corresponding to a selected heating level, or a maximum allowable power). Thus, given a heating element with a known resistance R, the current I can be regulated such that the desired power P is delivered to the heating element. As described above, in some cases, the current I is a waveform having a particular duty cycle. In these cases, the duty cycle of the current I can be regulated according to the relationship P=(Duty Cycle)V²/R, or (Duty Cycle)=PR/V², in order to maintain constant (or nearly constant) power delivery.

Further, the microcontroller 210 can also establish a maximum allowable duty cycle for the PWM waveform based on the detected voltage. For example, if a relatively low voltage is detected, the microcontroller 210 can define a relatively high maximum allowable duty cycle for the PWM waveform. Conversely, if a relatively high voltage is detected, the microcontroller 210 can define a relatively low maximum allowable duty cycle for the PWM waveform. As the amount of heat generated by the heating element 110 is at least partially proportional to the voltage of the power supply, limiting the duty cycle of the PWM waveform based on the detected voltage of the power supply 130 ensures that the duty cycle of the PWM waveform cannot be increased beyond safe limits. The relationship between the detected voltage and the maximum allowable duty cycle can vary based on the performance of safety tests, and can vary depending on the implementation.

This voltage measurement technique also can be beneficial, for example, as it allows power supplies having different voltages to be interchangeably used without requiring conversion to a standardized voltage. This can potentially reduce cost (e.g., by reducing the need for voltage conversion components), increase power efficiency (e.g., by reducing the need for efficiency-reducing voltage conversion steps), and increase the versatility of the control module 120 (e.g., by allowing it to be used directly with a wide variety of power supplies).

Although example duty cycles, voltages, and maximum allowable duty cycles are described above, these are merely illustrative examples. In practice, different combinations of duty cycles and voltages can be used, either in addition to or instead of those described above, in order to achieve the desired effect.

The current sensor 420 measures the current flowing along the electric circuit. Example current sensors 420 include a resistor-based current sensor, a Hall effect integrated circuit sensor, and a fiber optic current sensor. In some cases, the current sensor 420 can be implemented, either partially or completely, as a part of the microcontroller 210. For example, the microcontroller 210 can include analog to digital inputs for measuring the voltage across a resistor, having a known resistance, in series with the power supply 130 and the heating elements 110. As the resistance of the resistor is known, the current across the resistor thus can be determined based on the voltage measurements. The voltages inputted into this analog to digital input can be scaled as necessary, for example, using an operational amplifier circuit. As shown in FIG. 4, the current sensor 420 can be electrically coupled in series with the switch 220 and the power supply 130, such that it can measure the current that flows between each of these components. The current measurement is then transmitted from the current sensor 420 for analysis by the microcontroller 210. Based on the current measurement, the microcontroller 210 can adjust the operation of the switch 220.

For example, based on current measurements by the current sensor 420, the microcontroller 210 can determine when an undesirably high amount of current is flowing. For instance, if the measured current exceeds a particular upper threshold current, this can correspond to a short circuit or overcurrent that could potentially injure the user and/or damage the textile article 100. In response, the microcontroller 210 can open the switch 220 (e.g., by sending a PWM waveform with a 0% duty cycle or otherwise switching off the textile article 100) in order to reduce the risk of injury or damage. In some cases, this upper threshold current can be determined based on the performance of safety and comfort tests.

As another example, based on current measurements by the current sensor 420, the microcontroller 210 can determine when an undesirably low amount of current is flowing. For example, if the measured current decreases below a particular lower threshold current while the switch 220 is closed, this can correspond to malfunctioning component of the textile article 100 that could potentially injure the user and/or damage the textile article 100. For example, a malfunctioning switch 220, power supply 130, or heating element 110, or a malfunctioning electrical connection between these components can result in an undesirably low amount of current. In response, the microcontroller 210 can open the switch 220 (e.g., by sending a PWM waveform with a 0% duty cycle or otherwise switching off the textile article 100) in order to reduce the risk of injury or damage.

In some cases, this lower threshold current can correspond to a particular impedance determination. For example, a heating element 110 is often designed to have a particular known impedance (or range of known impedances). As the heating element 110 degrades, it will often increase in impedance, and correspondingly, will result in a decreased flow of current. Thus, the lower threshold current can be selected such that it corresponds to a highest acceptable impedance of the heating element 110. Accordingly, if the measured current decreases below the lower threshold current, this can indicate an undesirably high impedance, and correspondingly, can indicate a degraded heating element 110. In response, the microcontroller 210 can open the switch 220 in order to reduce the risk of injury or damage.

For instance, a broken or cracked wire can increase the effective impedance of the electric circuit coupling the power supply 130 and the heating element 130, and as a result, can reduce the current flowing between the power supply 130 and the heating element 110. In these situations, although the current flowing between the power supply 130 and the heating element 110 is decreased, due to the increase in the effective impedance of the circuit, the amount of power delivered to the electric circuit might remain relatively high. For instance, although the current flowing through the electric circuit might be reduced, due to the increased effective impedance of the electric circuit, the power delivered to the breakage point of the electric circuit (e.g., a cracked wire) might still cause a potentially hazardous condition (e.g., burns or fire). Thus, the lower threshold current can be selected such that it corresponds to a highest acceptable effective impedance of the electric circuit. Accordingly, if the measured current decreases below the lower threshold current, this can indicate an undesirably high effective impedance, and correspondingly, a damaged electric circuit. In response, the microcontroller 210 can open the switch 220 in order to prevent or reduce the likelihood of potentially hazardous conditions.

As an example, some heating elements have a nominal impedance in the range of 3-20Ω. When these heating elements are operating normally, they may have an impedance that varies within a particular tolerance range (e.g., ±15%). In some cases, the upper threshold current and/or lower threshold current can be selected such that they correspond to this tolerance range. Thus, if the heat element's impedance is not within this tolerance range, the microcontroller 210 suspends the flow of current. In some cases, the upper threshold current and/or lower threshold current need not correspond exactly to this tolerance range. For example, in some cases, the upper threshold current and/or lower threshold current can be selected such that they correspond to a broader range (e.g., ±25% the nominal impedance of the heating elements). Although example values are described, this are merely illustrative. In practice, other impedances, tolerance ranges, and threshold currents are possible, depending on the implementation.

In some cases, based on current measurements by the current sensor 420, the microcontroller 210 can determine when the amount of current is within a particular current range when the switch 220 is closed (e.g., whether the current is between an upper threshold value and a lower threshold value). If the microcontroller 210 determines that the current is not within the current range when the switch 220 is closed, in response, the microcontroller 210 can open the switch 220 (e.g., by sending a PWM waveform with a 0% duty cycle or otherwise switching off the textile article 100) in order to reduce the risk of injury or damage. Thus, a microcontroller can detect both undesirably high and undesirably low current when the switch 220 is closed, and adjust the operation of the switch 220 accordingly.

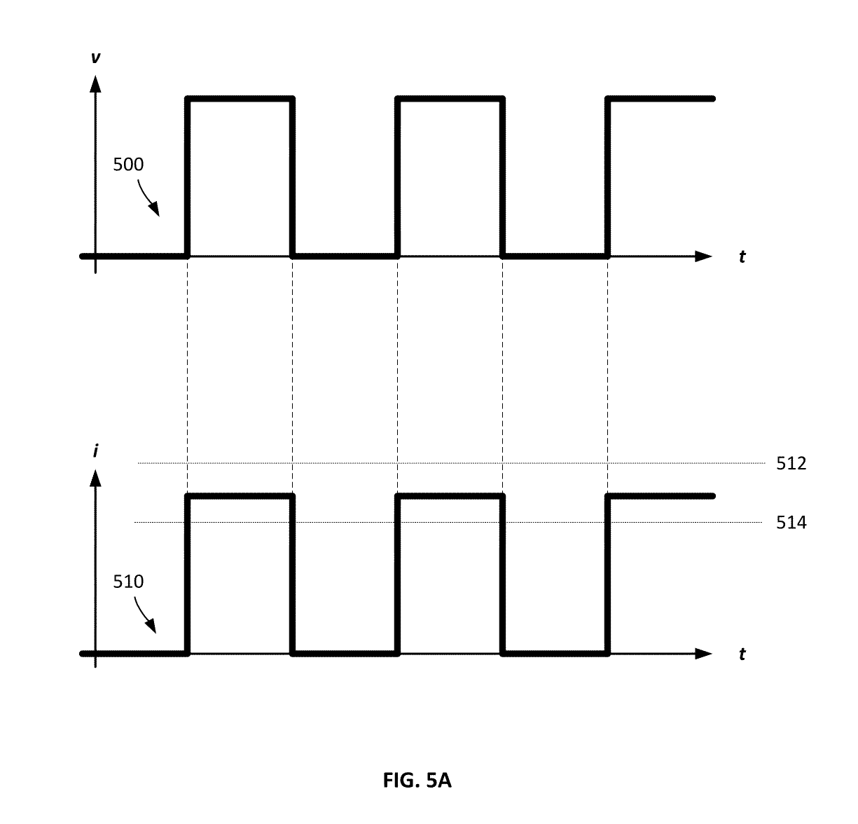

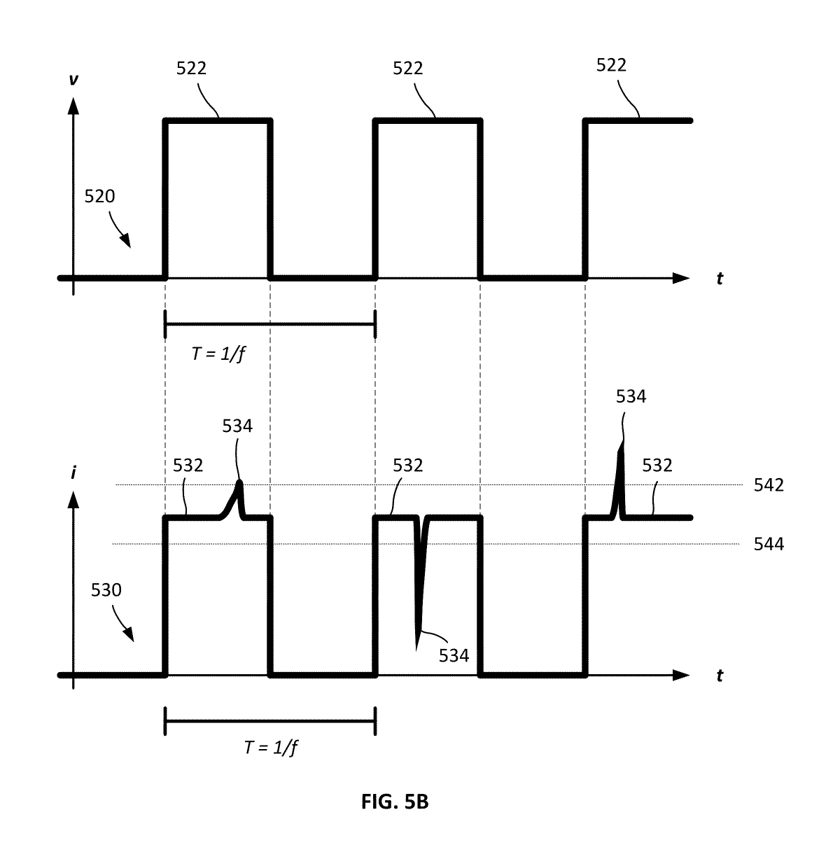

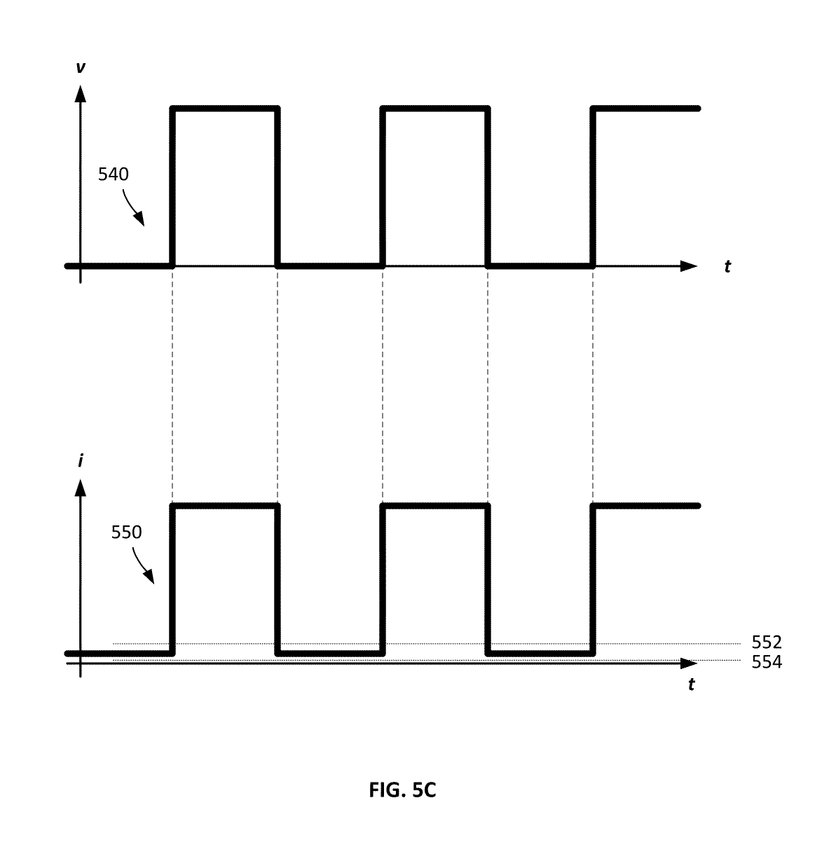

As an example, FIG. 5A shows a PWM waveform 500. The PWM waveform 500 is similar to the PWM waveform 300 shown in FIG. 3. FIG. 5A also shows an example current waveform 510 that results between the power supply 130 and the heating element 110 when the PWM waveform 500 is applied to the switch 220. FIG. 5A also shows an upper threshold current (indicated by dotted line 512), and a lower threshold current (indicated by dotted line 514). If the waveform 510 increases beyond the upper threshold current 514, or drops below a lower threshold current 516 while the switch 220 is closed (e.g., when the PWM waveform 500 is “active”), the microcontroller 210 can determine that the current is at an unsafe level, and can open the switch 220. Voltage and/or current measurements can be obtained continuously, periodically, or according to an arbitrary pattern. For example, in some cases, one or more measurements are obtained for each period T of the PWM waveform. For example, for each period T, one, two, three, four, five, or more measurements can be obtained during that time. These measurements can be transmitted from the sensors to the microcontroller 210 in substantially real-time (e.g., immediately after each measurement is obtained), or after a delay (e.g., after multiple measurements have been obtained). After the microcontroller 210 receives one or more measurements from the sensors, the microcontroller 210 determines if the measurements exceed a particular threshold value and/or if the measurements are within particular window.

In some cases, in order to determine if an undesirably high and/or undesirably low amount of current is flowing, the microcontroller 210 can determine, based on the measurements, the maximum and/or minimum current that was measured during each period of time that the switch 220 is closed (e.g., during each pulse of the PWM waveform). Thus, for each individual time interval that the PWM is “active,” a corresponding maximum and/or minimum current that was measured during that interval of time is determined. Thus, the effects of each pulse of the PWM waveform can be individually analyzed in order to determine if the textile article 100 is operating as desired. Similarly, a maximum and/or minimum measured voltage can also be determined, either instead of or in addition to determining maximum and/or minimum measured current. This can be beneficial as it allows the microcontroller 210, in some cases, to more readily detect intermittent problem (e.g., an intermittent connection between components or intermittent electrical arcing), and to detect intermittent problems with a greater degree of sensitivity.

An example of a PWM waveform 500 is shown in FIG. 5B. The PWM waveform 520 is similar to the PWM waveform 300 shown in FIG. 3, and includes several pulses 522 occurring at a frequency f, corresponding to a period T of 1/f. FIG. 5B also shows an example current waveform 530 that results between the power supply 130 and the heating element 110 when the PWM waveform 520 is applied to the switch 220. The current waveform 530 includes several pulses 532 occurring at a frequency f, corresponding to a period T of 1/f (similar to that of the PWM waveform 520). Each of the pulses 532 corresponds to a respective pulse 522 of the PWM waveform 520, indicating that current flows when the PWM waveform 520 is “active,” and that current does not flow when the PWM waveform 520 is “inactive.” However, the waveform 530 also includes several variations in current 534, indicating that the current flowing between the power supply 130 and the heating 110 is not uniform when the PWM waveform 520 is active. These variations in current 534 can correspond to, for example, intermittent problem such as an intermittent connection between components or intermittent electrical arcing between electrical connections.

To detect these variations in current 534, the microcontroller 220 can obtain one or more measurements of the current waveform 530 during each period of time that the switch 220 is closed (e.g., during each pulse 522 of the PWM waveform 520). Based on these measurements, the microcontroller 220 can determine the maximum and/or minimum measured current for each period of time. If the maximum measured current exceeds a particular upper threshold value (e.g., an upper threshold current 540), the microcontroller 220 can open the switch 220 (e.g., by sending a PWM waveform with a 0% duty cycle or otherwise switching off the textile article 100) in order to reduce the risk of injury or damage. Similarly, the microcontroller 220 can determine the minimal measured current of the current waveform 310 when the switch 220 is closed (e.g., during each pulse 502 of the PWM waveform 500). If the minimum measured current is below a particular lower threshold value (e.g., a lower threshold current 542) the microcontroller 220 can also open the switch 220 (e.g., by sending a PWM waveform with a 0% duty cycle or otherwise switching off the textile article 100) in order to reduce the risk of injury or damage. The upper and lower threshold values can differ, depending on the implementation.

In some cases, the microcontroller 220 can make a single current measurement during each period of time that the switch 220 is closed. In these implementations, the microcontroller 220 can simply determine if each current measurement is within the allowable current range (e.g., between the upper and lower threshold values). In some cases, the microcontroller 220 can make multiple current measurements during each period of time that the switch is closed (e.g., two, three, four, five, or more times during each period of time that the switch 220 is closed). In these implementations, in some cases, the microcontroller 220 can determine if each current measurement is within the allowable current range (e.g., less than the upper threshold current, greater than the lower threshold current, or both). Alternatively, in some cases, the microcontroller 220 can first identify, from among the current measurements obtained for each period of time, the maximum and/or minimum current value measured during that period of time. The microcontroller 220 can then determine if each of these maximum and/or minimum current measurements are within the allowable current range (e.g., less than the upper threshold current, greater than the lower threshold current, or both). In this manner, the microcontroller 220 can estimate the peak or minimum current that is flowing when the switch 220 is closed, and use this estimate to regulate the operation of the switch 200. In some cases, measurements can be made instantaneously, or nearly-instantaneously (as limited to the capabilities of the microcontroller 220). For example, in some case, each measurement can occur nearly instantaneously, and each measurement can occur over a length of time that is substantially less than the period of time that the switch is closed (e.g., 1%, 2%, 5%, 10%, and so forth).

In the above examples, the microcontroller determines the maximum and minimum measured current of the current waveform 550 when the switch 220 is closed (e.g., during each pulse 502 of the PWM waveform 500) in order to regulate the flow of current across the switch 220. In practice, however, the microcontroller 220 can also determine the maximum and minimum measured current of the current waveform 550 across several pulses 502 (e.g., two, three, four, or more pulses) in order regulate the flow of current.

In the above examples, the microcontroller adjusts the operation of the switch 220 based on current measurements obtained when the switch 220 is closed. In some implementations, however, the microcontroller can adjust the operation of the switch 220 based on current measurement obtained when the switch 220 is open. For example, while the switch 220 is open, a secondary power module can close the electrical circuit (e.g., by bypassing the switch 220) and apply a small amount of current to the electrical circuit. The current sensor 420 can then measure the amount of current flowing across it when the switch 220 is open, and can use these measurements to assess the operation. As an example, FIG. 5C shows a PWM waveform 540. The PWM waveform 540 is similar to the PWM waveform 300 shown in FIG. 3. FIG. 5C also shows an example current waveform 550 that results between the power supply 130 and the heating element 110 when the PWM waveform 540 is applied to the switch 220. FIG. 5C also shows an upper threshold current (indicated by dotted line 552), and a lower threshold current (indicated by dotted line 554). If the waveform 510 increases beyond the upper threshold current 552, or drops below a lower threshold current 554 while the switch 220 is open (e.g., when the PWM waveform 500 is “inactive”), the microcontroller 210 can determine that the current is at an unsafe level, and can keep the switch 220 open.

In several of the above examples, the microcontroller 210 is described as comparing the measured current to a particular current range (e.g., by determining whether the measured is simultaneously less than an upper threshold current and greater than a lower threshold current). In some cases, however, the microcontroller 210 can compare the measured current to a single threshold value (e.g., either by determining whether the measured current is less than an upper threshold current, or by determining whether the measured current is great than a lower threshold current). Thus, in some cases, the microcontroller 210 need not determine whether the measured current is within a particular finite range, and instead can determine whether the measured current exceeds or decreases beyond a particular threshold value.

The temperature sensor 430 measures the temperature of a particular area about the textile article 100. As an example, the temperature sensor 430 can be a thermistor. As shown in FIG. 4, in some implementations, the temperature sensor 430 can be positioned in proximity to the heating element 110 in order to measure the temperature of the heating element 110. In some cases, a temperature sensor 430 can be positioned such that it is proximity to the user (e.g., along an interior or user-facing region of the textile article 100), in order to measure the temperature of the user. In some cases, a temperature sensor 430 can be positioned along an exterior, or environment-facing region of the textile article 100 in order to measure the temperature of the surrounding environment. Although only a single temperature sensor is shown in FIG. 4, in practice any number of temperature sensors can be used to measure the temperature from any number of different areas.

After the temperature sensors obtain temperature measurements, the temperature measurements are transmitted to the microcontroller 210 for analysis. Based on the temperatures measurement, the microcontroller 210 can adjust the operation of the switch 220.

For example, if a temperature sensor 430 is placed in proximity to the heating element 110, the microcontroller 210 can determine when an undesirably high amount of heat is being produced by the heating element 110. As an example, in some cases, the temperature sensor 430 (e.g., a thermistor) can be attached directly to the heating element 110 (e.g., affixed to a heating element using glue, or wrapped around a heating element using tape). If the measured temperature exceeds a particular upper threshold temperature, this can correspond to a short circuit or overcurrent that could potentially injure the user and/or damage the textile article 100. In response, the microcontroller 210 can open the switch 220 (e.g., by sending a PWM waveform with a 0% duty cycle or otherwise switching off the textile article 100) in order to reduce the risk of injury or damage. In some cases, this upper threshold temperature can be determined based on the performance of safety and comfort tests.

As another example, the temperature measurements obtained by the temperature sensor 430 can be used to regulate the amount of heat produced by the heating element 110. For example, the microcontroller 210 determine the temperature of the user-facing region of the textile article 100, and compare this value against a target temperature value (e.g., a temperature value specified by the user). Based on this comparison, the microcontroller 210 can adjust the operation of the switch 220 in order to achieve and maintain this temperature. For example, if the temperature of the user-facing region of the textile article 100 is higher than the specified temperature value, the microcontroller 210 can open the switch 220 (e.g., by sending a PWM waveform with a 0% duty cycle), or reduce the percentage of time that the switch 220 is closed (e.g., by sending a PWM waveform with a smaller duty cycle than before). As another example, if the temperature of the user-facing region of the textile article 100 is lower than the specified temperature value, the microcontroller 210 can increase the percentage of time that the switch 220 is closed (e.g., by sending a PWM waveform with a larger duty cycle than before). In this manner, the temperature sensors 430 provide feedback to help regulate the operation of the textile article 100. As another example, if the temperature of the user-facing region of the textile article 100 is higher than a maximum allowable temperature (e.g., approximately 37° C.), the microcontroller 210 can open the switch 220, or reduce the percentage of time that the switch 220 is closed.

In some implementations, the microcontroller 210 can use one or more temperature sensors 430 to determine if the textile article 100 is in use. For instance, one or more temperature sensors 430 can be placed along a user-facing region of the textile article 100. As an example, if the textile article 100 is a coat, one or more temperature sensors 430 can be positioned such that they are in proximity with the user when the coat is worn (e.g., along an interior lining of the coat that faces the user during use). As another example, if the textile article 100 is a blanket, one or more temperature sensors 430 can be positioned such that they are in proximity with the user when the blanket is draped over the user (e.g., along the side of the blanket that faces the user during use).

When the microcontroller 210 detects a sudden rate of change in temperature (e.g., a sudden drop in temperature), the microcontroller 210 can determine that the user has removed the textile article 100 from his body. In response, the microcontroller 210 can open the switch 220 (e.g., by sending a PWM waveform with a 0% duty cycle) to suspend the generation of heat. As an example, the microcontroller 210 can detect a sudden rate of decrease (e.g., a rate of decrease that exceeds a particular threshold rate of decrease), and in response, open the switch 220. This can be beneficial, for example, as it reduces the likelihood that the textile article 100 is unnecessarily generating heat. Thus, the textile article 100 can use electrical power more efficiently. In some cases, the microcontroller 210 can consider measurements from multiple temperature sensors 430 to determine if the user has removed the textile article 100 from his body. For instance, the textile article 100 can include multiple sensors situated at different positions of the textile article 100. The microcontroller 210 can consider measurements from one or more of these temperature sensors 430 in order to determine if the user has removed the textile article 100. For example, the microcontroller 210 can average measurements obtained from two or more temperature sensors 430 in order to make a determination. For example, if the textile article is a coat, one or more temperature sensors 430 can be placed each of several different regions of the coat (e.g., the front torso region, back torso region, the neck region, and/or the sleeve region, and so forth). Measurements from each of these regions can be averaged in order to determine if the coat has been removed from the user. This can be beneficial as temperature measurements from a single temperature sensor 430, in some cases, can vary based on motion (e.g., when the textile article 100 shifts with respect to the user), or based on localized temperature changes (e.g., when the textile article is in proximity with a localized source of heat or cooling). By considering measurements from multiple temperature sensors 430, the microcontroller 210 can make a determination that is less sensitive to these types of events.

As another example, the microcontroller 210 can consider measurements obtained from two or more temperature sensors 430, but weigh measurements from some temperature sensors 430 more than measurements from others. In this manner, measurements from some temperature sensors 430 have more influence on the determination. For example, if the textile article is a coat, one or more temperature sensors 430 can be placed each of several different regions of the coat (e.g., the front torso region, back torso region, the neck region, and/or the sleeve region, and so forth). The microcontroller 210 can weigh measurements obtained from some of the temperature sensors 430 (e.g., those positioned along the front and back torso region) such that they have more influence on the determination that measurements obtained from other temperature sensors 430 (e.g., those positioned along the sleeve regions). Although an example of how different measurements can be weighted differently depending on temperature sensor location, this is merely an illustrative example. In practice, measurements can be weighted differently (e.g., by emphasizing or deemphasizing regions differently), depending on the implementation.

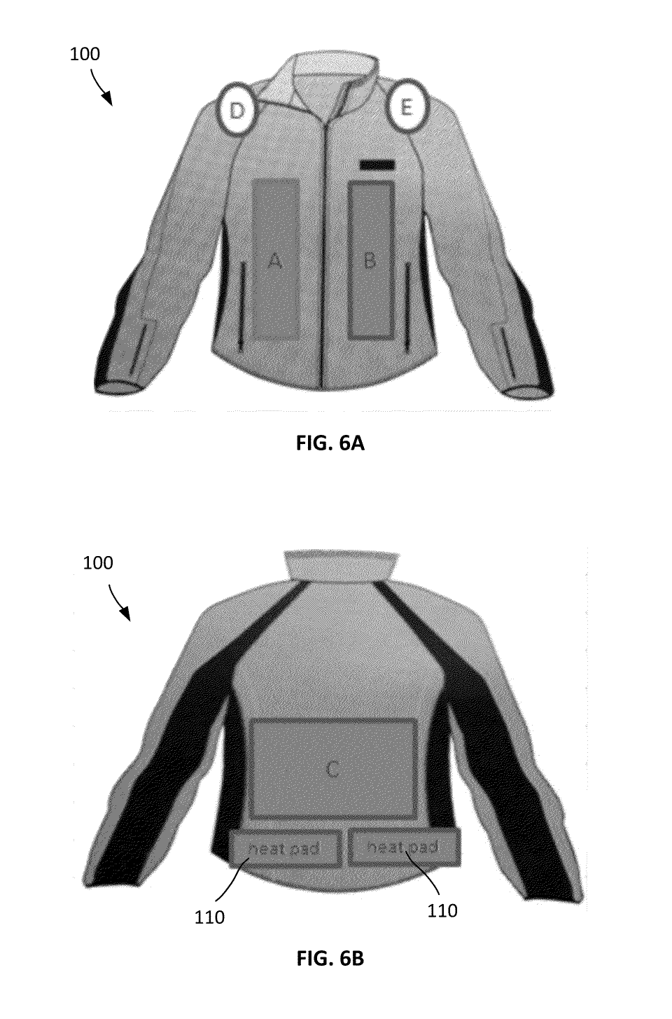

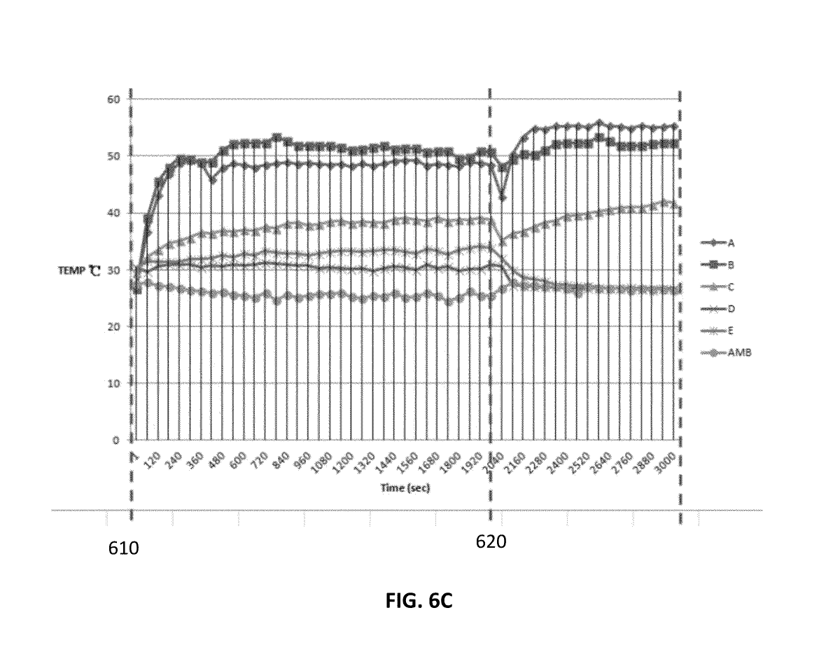

An example implementation of a textile article 100 is shown in FIGS. 6A-B. In this example, the textile article 100 is a coat, and includes multiple heating elements 110 embedded within it, and multiple temperature sensors that measurement temperature from regions A-E within the coat; although the heating elements 110 and the regions A-E are shown outside of the coat for clarity in FIGS. 6A-B, the heating elements 110 and the regions A-E refer to components/regions within the coat. FIG. 6C shows example temperature measurements taken from each of the regions A-E (indicated by plots A-E), and the ambient temperature (indicated by plot AMB), starting from the point in time when the user puts on the coat (time 610), and continuing to a point in time after the user removes the coat (time 620). As shown in FIG. 6C, when the user puts on the coat (time 610) and activates the heating elements 110, the measured temperature from each of the regions A-E increases over time. However, when the user removes the coat (time 620), the measured temperatures decrease sharply. Thus, the microcontroller 210 can detect a drop in one or more of the temperature measurements over time in order to determine when the user has removed the coat. For example, the microcontroller 210 can detect a rate of decrease that exceeds a threshold rate of decrease, and/or the microcontroller 210 can detect an absolute decrease in temperature that exceeds a threshold amount. In response, the microcontroller 210 can suspend heat generation (e.g., by opening switch 220), to ensure that power is not unnecessary expended. In some cases, the microcontroller 210 can consider measurements from a single region, or measurements from multiple regions. In some cases, the microcontroller 210 can consider multiple measurement equally (e.g., by considering the average temperature across multiple regions), or it can consider some weight measurements from some regions more highly than others.

In some cases, the microcontroller 210 can also determine if the measurements obtained from the sensors 410, 420, and 430 are within an allowable range. If the measurements are not within the allowable range, this may indicate that the sensors are malfunctioning, and that the measurements are not reliable. In response, the microcontroller 210 can open the switch 220 to ensure that no current will be input into the heating element 110. As an example, a temperature sensor 430 positioned on the exterior of a textile article 100 can have an allowable range that spans the range of ambient temperatures expected to be seen during use of the textile article 100 (e.g., between −40° C. and 10° C.). If a temperature measurement is obtained that is not within this allowable range, the microcontroller 210 can determine that the temperature sensor 430 is malfunctioning, and can open the switch 220. A similar determination can also be performed for each of the other sensors (e.g., for the voltage sensor 410 and the current sensor 420).

Although three example sensors are described above (e.g., a current sensor, a voltage sensor, and a temperature sensor), other sensors also can be used, either in addition to or instead of those described above. For example, in some cases, the textile article 100 can include an accelerometer that measures movement of the textile article 100, and transmits the measurement information to the microcontroller 210 for analysis. Based on the measurement information, the microcontroller 210 can determine if the textile article 100 is in use. For example, if the microcontroller 210 the textile article 100 is moving (e.g., by determining that the measurement information indicates recent movement), the microcontroller 210 can determine that the textile article 100 is being worn. In response, the microcontroller 210 can allow current to flow from the power supply 130 to the heating element 110 in order to generate heat. If the microcontroller 210 the textile article 100 has not recently moved (e.g., by determining that the measurement information indicates no movement for a period of time, for example several minutes or any other threshold period of time), the microcontroller 210 can determine that the textile article 100 is not being worn. In response, the microcontroller 210 can prevent current from flow from the power supply 130 to the heating element 110, preventing the generation of heat. In practice, other types of sensors are also possible.

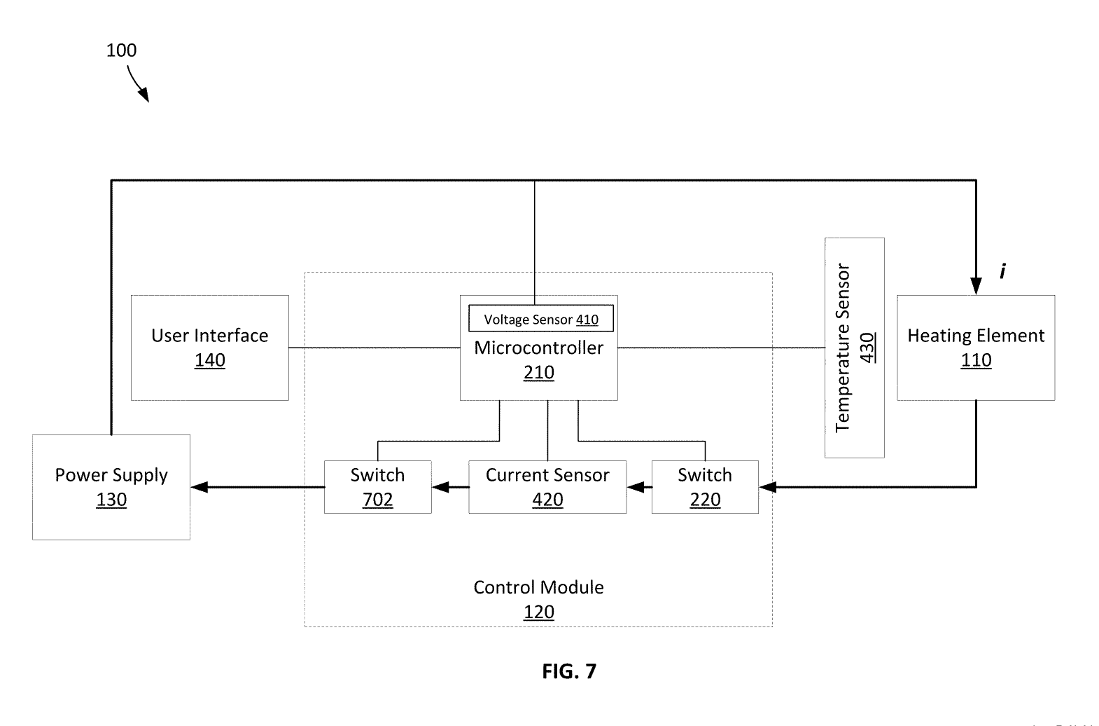

In the above examples, the microcontroller 210 controls the flow of current between the power supply 130 and the heating element 110 by opening and closing a switch 220. In some cases, however, the microcontroller 210 can control the flow of current by opening and closing a secondary switch in addition to the switch 220. An example of textile article 100 having this arrangement is shown in FIG. 7. The textile article shown in FIG. 7 is similar to that shown in FIG. 4. For example, the textile article 100 includes a heating element 110, a control module 120, a power supply 130, and a user interface 140, and each can have similar functionality as that described above. As with the textile article 100 shown in FIG. 4, the control module 120 shown in FIG. 7 includes a switch 220 and a current sensor 420 coupled in series with the power supply 130 and the heating element 110. However, the control module 120 additionally includes a secondary switch 702 in series with the power supply 130, the heating element 110, the switch 220, and the current sensor 420 that also regulates current across the circuit. The switch 702 is electrically coupled to the microcontroller 210, such that the microcontroller 210 can control the operation of the switch 702 by transmitting control signals to the switch 702 (e.g., opening and closing the switch by transmitting PWM waveforms). In some cases, the switch 702 can provide the current cut-off functionality described above. For example, if the microcontroller 210 determines that current should not flow through the heating element 110 (e.g., due to any one of the conditions described above), the microcontroller 210 can open switch 702, such that the circuit is broken and the heating element 110 no longer generates heat. In some cases, the microcontroller 210 can operate the switch 220 to provide a particular level of heating (e.g., by sending a PWM waveform having a particular duty cycle), and operate the switch 702 to provide current cut-off (e.g., by closing the switch when the circuit is operating normally and opening the switch when an abnormal condition is detected). In some cases, the microcontroller 210 can operate the switch 702 and the switch 220 in an identical manner, such that in the event of a failure one of the switches 220 or 702, current is less likely to flow across the heating element 110 when it is not desired.

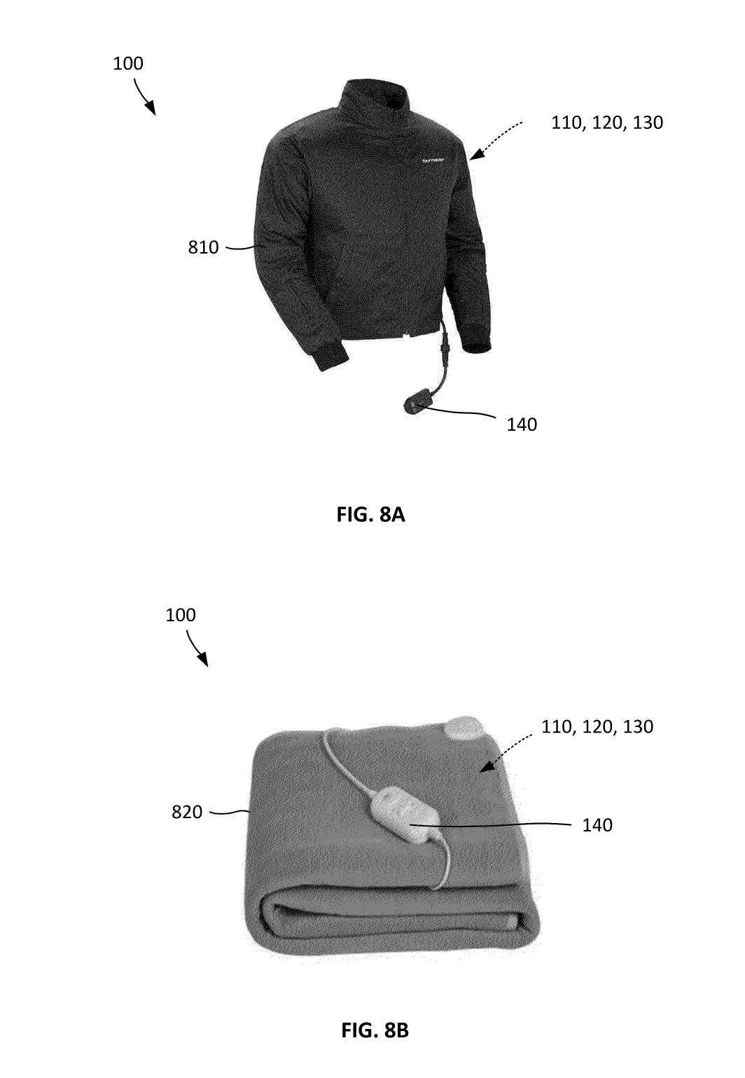

Example implementations of the textile article 100 are shown in FIGS. 8A-B. As shown in FIG. 8A, an example implementation of the textile article 100 can include a coat 810, with each of the components of the textile article 100 (e.g., the heating element 110, the control module 120, the power supply 130, and the user interface 140) either embedded within the coat 810 or attached to the coat 810. For example the heating element 110, the control module 120, and the power supply 130 can be sewn into the coat 810 (e.g., underneath one or more layers of the coat 610, or within an exterior or interior pocket of the coat 810). As another example, the user interface 140 can be attached to the coat 810 such that it is accessible to the user.

As shown in FIG. 8B, another example implementation of the textile article 100 can include a blanket 820, with each of the components of the textile article 100 (e.g., the heating element 110, the control module 120, the power supply 130, and the user interface 140) either embedded within the blanket 820 or attached to the blanket 820. For example the heating element 110, the control module 120, and the power supply 130 can be sewn into the blanket 820 (e.g., underneath one or more layers of the blanket 820, or within an exterior or interior pocket of the blanket 20). As another example, the user interface 140 can be attached to the blanket 820 such that it is accessible to the user. In some cases, the components of the textile article 100 can be reversibly detached from the blanket 20, for example so that the blanket 820 can be washed without damaging the other components of the textile article 100

Although a coat 810 and blanket 820 are shown in the examples above, these are merely illustrative examples. In practice, the textile article 100 can include any type of textile article. For example, in some implementations, the textile article 100 can include coats, jackets, blankets, hats, gloves, scarves, pants, ear muffs, socks, or any other textile article.

Some implementations of subject matter and operations described in this specification can be implemented in digital electronic circuitry, or in computer software, firmware, or hardware, including the structures disclosed in this specification and their structural equivalents, or in combinations of one or more of them. For example, all or part of the control module 120 (e.g., the microcontroller 210 and the switch), the user interface 140, and the sensors 410, 420, and 430 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of implementations have been described. Nevertheless, it will be understood that various modifications may be made without departing from the spirit and scope of the disclosure. Accordingly, other embodiments are within the scope of the following claims.

What is claimed is:

1. A heating control module comprising:
a microcontroller; and
a switch operatively coupled to the microcontroller;
wherein the switch is arranged to allow current to flow between a power supply and one or more heating elements during a closed state and to prevent current from flowing between the power supply and the heating elements during an open state, and
wherein the microcontroller is configured to:
receive, from a user interface, an indication of a heating level;
transmit, in response to receiving the indication, a control signal to the switch such that a current waveform corresponding to the heating level flows between the power supply and the heating elements;
obtain, during the closed state of the switch, one or more measurements of the current delivered to the heating element;
compare the one or more measurements to a lower threshold current; and
open the switch upon determining that at least one measurement is less than the lower threshold current.

2. The heating control module of claim 1, wherein the microcontroller is further configured to:
compare the one or more measurements to an upper threshold current; and
open the switch upon determining that at least one measurement exceeds the upper threshold current.

3. The heating control module of claim 1, wherein a duration of each measurement is substantially less than the period of time that the switch is closed.

4. The heating control module of claim 1, wherein the control signal comprises a pulse-width modulated waveform having a duty cycle that is proportional to the heating level.

5. The heating control module of claim 1, wherein the control signal comprises a periodic waveform having a frequency that is proportional to the heating level.

6. The heating module of claim 1, wherein the microcontroller is further configured to:
obtain a temperature measurement using a temperature sensor;
determine whether the temperature measurement exceeds a threshold temperature; and
upon determining that the measured temperature exceeds the threshold temperature, open the switch.

7. The heating control module of claim 6, wherein the measured temperature corresponds to a temperature of the heating element.

8. The heating control module of claim 1, wherein the microcontroller is further configured to:
obtain, over a second period of time, a plurality of temperature measurements using a temperature sensor;
determine whether the temperature measurements correspond to a rate of decrease that exceeds a threshold rate of decrease; and
upon determining that the temperature measures correspond to a rate of decrease that exceeds the threshold rate of decrease, open the switch.

9. The heating control module of claim 8, wherein the temperature sensor is disposed with an article of clothing to be worn by a user, and wherein the temperature measurements correspond to a temperature from an area of the article of clothing that is intended to be close to the user.

10. The heating control module of claim 1, wherein the control signal comprises a pulse-width modulated waveform; and
wherein the microcontroller is further configured to:
measure a voltage across the power supply; and
set a maximum allowable duty cycle of the control signal based on the measured voltage.

11. The heating control module of claim 10, wherein the microcontroller is further configured to set a minimum allowable duty cycle of the control signal based on the measured voltage.

12. The heating control module of claim 1, wherein the heating control module further comprises the power supply and the heating element.

13. The heating control module of claim 1, wherein the microcontroller is further configured to:
obtain one or more acceleration measurements using an accelerometer;
determine whether the acceleration measurements correspond to a recent movement;
upon determining that the acceleration measurements do not correspond to a recent movement, open the switch.

14. A heating control module comprising:
a microcontroller; and
a switch operatively coupled to the microcontroller, wherein the switch is arranged to allow current to flow between a power supply and one or more heating elements during a closed state and to prevent current from flowing between the power supply and the heating elements during an open state, and
wherein the microcontroller is configured to:
receive, from a user interface, an indication of a heating level;
receive measurement data from one or more sensors;
transmit, in response to receiving the measurement data, a control signal to the switch such that a current waveform corresponding to the heating level flows between the power supply and the heating elements;
obtain, during the closed state of the switch, one or more measurements of the current delivered to the heating element;
compare the one or more measurements to a lower threshold current; and
open the switch upon determining that at least one measurement is less than the lower threshold current.

15. The heating control module of claim 14, wherein the one or more sensors comprise a temperature sensor, and wherein the measurement data comprises temperature measurements.

16. The heating control module of claim 15, wherein the control signal comprises a pulse-width modulated waveform having a duty cycle that corresponds to the heating level and the temperature measurements.

17. The heating control module of claim 14, wherein the microcontroller is further configured to:
compare the one or more measurements to an upper threshold current; and
open the switch upon determining that at least one measurement exceeds the upper threshold current.

18. The heating control module of claim 14, wherein a duration of each measurement is substantially less than the period of time that the switch is closed.

19. The heating module of claim 14, wherein the microcontroller is further configured to:
obtain a temperature measurement using a temperature sensor;
determine whether the temperature measurement exceeds a threshold temperature; and
upon determining that the measured temperature exceeds the threshold temperature, open the switch.

20. The heating control module of claim 19, wherein the measured temperature corresponds to a temperature of the heating element.

21. The heating control module of claim 14, wherein the microcontroller is further configured to:
obtain, over a second period of time, a plurality of temperature measurements using a temperature sensor;
determine whether the temperature measurements correspond to a rate of decrease that exceeds a threshold rate of decrease; and
upon determining that the temperature measures correspond to a rate of decrease that exceeds the threshold rate of decrease, open the switch.

22. The heating control module of claim 21, wherein the temperature sensor is disposed with an article of clothing to be worn by a user, and wherein the temperature measurements correspond to a temperature from an area of the article of clothing that is intended to be close to the user.

23. The heating control module of claim 14, wherein the control signal comprises a pulse-width modulated waveform; and
wherein the microcontroller is further configured to:
measure a voltage across the power supply; and
set a maximum allowable duty cycle of the control signal based on the measured voltage.

24. The heating control module of claim 23, wherein the microcontroller is further configured to set a minimum allowable duty cycle of the control signal based on the measured voltage.

25. The heating control module of claim 14, wherein the heating control module further comprises the power supply and the heating element.

26. The heating control module of claim 14, wherein the microcontroller is further configured to:
obtain one or more acceleration measurements using an accelerometer;
determine whether the acceleration measurements correspond to a recent movement;
upon determining that the acceleration measurements do not correspond to a recent movement, open the switch.

27. A heating control module comprising:
a microcontroller; and
a first switch and a second switch each operatively coupled to the microcontroller;
wherein the first switch is configured to toggle between a closed state and an open state based on a first control signal received from the microcontroller, and wherein the first switch is arranged to allow current to flow across the first switch during the closed state and to prevent current from flowing across the first switch during the open state;
wherein the second switch is configured to toggle between a closed state and an open state based on a second control signal received from the microcontroller, and wherein the second switch is arranged to allow current to flow across the second switch during the closed state and to prevent current from flowing across the second switch during the open state; and
wherein when the first switch and the second switch are arranged to allow current to flow between a power supply and one or more heating elements when both switches are closed, and to prevent current from flowing between the power supply and the heating elements when at least one of the first switch or the second switch are open; and
wherein the microcontroller is configured to:
receive, from a user interface, an indication of a heating level;
transmit, in response to receiving the indication, the first control signal to the first switch, wherein when the first control signal is transmitted to the first switch and the second switch is closed, a current waveform corresponding to the heating level flows between the power supply and the heating elements;
obtain, during the closed state of the first switch, one or more measurements of the current delivered to the heating element;
compare the one or more measurements to a lower threshold current; and
open the second switch upon determining that at least one measurement is less than the lower threshold current.

28. The heating control module of claim 27, wherein the microcontroller is further configured to:
compare the one or more measurements to an upper threshold current; and
open the second switch upon determining that at least one measurement exceeds the upper threshold current.

29. The heating control module of claim 27, wherein a duration of each measurement is substantially less than the period of time that the first switch is closed.

30. The heating control module of claim 27, wherein the first control signal comprises a pulse-width modulated waveform having a duty cycle that is proportional to the heating level.

31. The heating control module of claim 27, wherein the first control signal comprises a periodic waveform having a frequency that is proportional to the heating level.

32. The heating module of claim 27, wherein the microcontroller is further configured to:
obtain a temperature measurement using a temperature sensor;
determine whether the temperature measurement exceeds a threshold temperature; and
upon determining that the measured temperature exceeds the threshold temperature, open the second switch.

33. The heating control module of claim 32, wherein the measured temperature corresponds to a temperature of the heating element.

34. The heating control module of claim 27, wherein the microcontroller is further configured to:
obtain, over a second period of time, a plurality of temperature measurements using a temperature sensor;
determine whether the temperature measurements correspond to a rate of decrease that exceeds a threshold rate of decrease; and
upon determining that the temperature measures correspond to a rate of decrease that exceeds the threshold rate of decrease, open the second switch.

35. The heating control module of claim 34, wherein the temperature sensor is disposed with an article of clothing to be worn by a user, and wherein the temperature measurements correspond to a temperature from an area of the article of clothing that is intended to be close to the user.

36. The heating control module of claim 27, wherein the control signal comprises a pulse-width modulated waveform; and
wherein the microcontroller is further configured to:
measure a voltage across the power supply; and
set a maximum allowable duty cycle of the control signal based on the measured voltage.

37. The heating control module of claim 36, wherein the microcontroller is further configured to set a minimum allowable duty cycle of the control signal based on the measured voltage.

38. The heating control module of claim 27, wherein the heating control module further comprises the power supply and the heating element.

39. The heating control module of claim 27, wherein the microcontroller is further configured to:
obtain one or more acceleration measurements using an accelerometer;
determine whether the acceleration measurements correspond to a recent movement;
upon determining that the acceleration measurements do not correspond to a recent movement, open the second switch.

40. A system for determining when a textile article is being worn, the system comprising:
one or more temperature sensors; and
a microcontroller operatively coupled to the one or more temperature sensors;
wherein the temperature sensors are configured to:
obtain, over a period of time, a plurality of temperature measurements; and
transmit the temperature measurements to the microcontroller; and
wherein the microcontroller is configured to:
receive the temperature measurements from the temperature sensors;
determine whether the temperature measurements correspond to the textile article being removed from a user's body.

41. The system of claim 40, wherein the microcontroller is further configured to:
upon determining that the temperature measurements correspond to the textile article being removed from the user's body, instructing a heat generating element disposed within the textile article to suspend heat generation.

42. The system of claim 40, wherein determining whether the temperature measurements correspond to the textile article being removed from a user's body comprises:
determining whether the temperature measurements correspond to a rate of decrease that exceeds a threshold rate of decrease; and
upon determining that the temperature measures correspond to a rate of decrease that exceeds the threshold rate of decrease, determining that the temperature measurements correspond to the textile article being removed from a user's body.

43. The system of claim 40, wherein the microcontroller is further configured to:
upon determining that the textile article is not being removed from the user's body, instructing a heat generating device associated with the textile article to generate heat.

44. The system of claim 40, wherein the textile article is an article of clothing to be worn by a user, and wherein the temperature measurements correspond to a temperature from one or more areas of the article of clothing that are intended to be close to the user.

45. The system of claim 40, further comprising:
a switch operatively coupled to the microcontroller;
wherein the switch is arranged to allow current to flow between a power supply and one or more heating elements during a closed state and to prevent current from flowing between the power supply and the heating elements during an open state; and
wherein the microcontroller is configured to:
upon determining that the temperature measurements correspond to the textile article being removed from a user's body, open the switch.

46. The system of claim 45, wherein the microcontroller is further configured to:
receive, from a user interface, an indication of a heating level;
transmit, in response to receiving the indication, a control signal to the switch such that a current waveform corresponding to the heating level flows between the power supply and the heating elements;
obtain, during the closed state of the switch, one or more measurements of the current delivered to the heating element;
compare the one or more measurements to a lower threshold current; and
open the switch upon determining that at least one measurement is less than the lower threshold current.

47. The system of claim 46, wherein the duty cycle of the control signal is proportional to the heating level.

48. The system of claim 46, wherein the microcontroller is further configured to:
obtain a temperature measurement temperature using the temperature sensors;
determine whether the temperature measurement exceeds a threshold temperature; and
upon determining that the measured temperature exceeds the threshold temperature, open the switch.

49. The system of claim 48, wherein the measured temperature corresponds to a temperature of the heating element.

50. The system of claim 46, wherein the microcontroller is further configured to:
measure a voltage across the power supply; and
determine a maximum allowable duty cycle of the control signal based on the measured voltage.

51. The system of claim 46, wherein the system further comprises the power supply and the heating element.

52. The system of claim 46, wherein the microcontroller is further configured to:
obtain one or more acceleration measurements using an accelerometer;
determine whether the acceleration measurements correspond to a recent movement;
upon determining that the acceleration measurements do not correspond to a recent movement, open the switch.

53. A heating control module comprising:
a microcontroller; and
a switch operatively coupled to the microcontroller;
wherein the switch is arranged to allow current to flow between a power supply and one or more heating elements during a closed state and to prevent current from flowing between the power supply and the heating elements during an open state, and
wherein the microcontroller is configured to:
receive, from a user interface, an indication of a heating level;
transmit, in response to receiving the indication, a control signal to the switch such that a current waveform corresponding to the heating level flows between the power supply and the heating elements;
apply, during the open state of the switch, current to an electric circuit coupling the power supply and the heating elements;
obtain, during the open state of the switch, one or more measurements of the current delivered to the heating element;
compare the one or more measurements to a lower threshold current; and
prevent the switch from closing upon determining that at least one measurement is less than the lower threshold current.

54. The heating control module of claim 53, wherein the microcontroller is further configured to:
compare the one or more measurements to an upper threshold current; and
open the switch upon determining that at least one measurement exceeds the upper threshold current.

55. The heating control module of claim 1, wherein a duration of each measurement is substantially less than the period of time that the switch is closed.

56. The heating control module of claim 53, wherein the control signal comprises a pulse-width modulated waveform having a duty cycle that is proportional to the heating level.

57. The heating control module of claim 53, wherein the control signal comprises a periodic waveform having a frequency that is proportional to the heating level.

58. The heating module of claim 53, wherein the microcontroller is further configured to:
obtain a temperature measurement using a temperature sensor;
determine whether the temperature measurement exceeds a threshold temperature; and
upon determining that the measured temperature exceeds the threshold temperature, open the switch.

59. The heating control module of claim 58, wherein the measured temperature corresponds to a temperature of the heating element.

60. The heating control module of claim 53, wherein the microcontroller is further configured to:
obtain, over a second period of time, a plurality of temperature measurements using a temperature sensor;
determine whether the temperature measurements correspond to a rate of decrease that exceeds a threshold rate of decrease; and
upon determining that the temperature measures correspond to a rate of decrease that exceeds the threshold rate of decrease, open the switch.

61. The heating control module of claim 60, wherein the temperature sensor is disposed with an article of clothing to be worn by a user, and wherein the temperature measurements correspond to a temperature from an area of the article of clothing that is intended to be close to the user.

62. The heating control module of claim 53, wherein the control signal comprises a pulse-width modulated waveform; and
wherein the microcontroller is further configured to:
measure a voltage across the power supply; and
set a maximum allowable duty cycle of the control signal based on the measured voltage.

63. The heating control module of claim 62, wherein the microcontroller is further configured to set a minimum allowable duty cycle of the control signal based on the measured voltage.

64. The heating control module of claim 53, wherein the heating control module further comprises the power supply and the heating element.

65. The heating control module of claim 53, wherein the microcontroller is further configured to:
obtain one or more acceleration measurements using an accelerometer;
determine whether the acceleration measurements correspond to a recent movement;
upon determining that the acceleration measurements do not correspond to a recent movement, open the switch.
